(19) United States
(12) Patent Application Publication
(10) Pub. No.: US 2024/0060470 A1
(43) Pub. Date: Feb. 22, 2024

(54) Wind Turbine with a Virtual Hydrogen Battery

(71) Applicant: Jeremy J Papadopoulos, Manchester (GB)

(72) Inventor: Jeremy J Papadopoulos, Manchester (GB)

(73) Assignee: T-Omega Wind, Milton, MA (US)

(21) Appl. No.: 18/451,667

(22) Filed: Aug. 17, 2023

Related U.S. Application Data
(60) Provisional application No. 63/371,674, filed on Aug. 17, 2022.

(51) Int. Cl. F03D 9/19; F03D 13/25; C25B 5/00; C25B 1/04; C25B 9/65

(52) U.S. Cl. CPC F03D 9/19; F03D 13/25; C25B 5/00; C25B 1/04; C25B 9/65; F05D 2260/42

(57) ABSTRACT

An apparatus for converting mechanical energy from wind to fluid-fuel energy is an offshore wind-turbine apparatus. Electrical energy generated by the turbine is used in an electrolysis process to convert sea water to fluid fuel. The fuel may be stored in tanks beneath the water surface or on the ocean floor.

### TECHNICAL FIELD

The present disclosure relates in general to energy storage and retrieval methods and to offshore wind turbines that generate hydrogen for energy storage.

### BACKGROUND

A wind turbine is a rotating machine that converts kinetic energy from wind into mechanical energy that is converted to electricity. Utility-scale, horizontal-axis wind turbines have horizontal shafts that drive a generator assembly within a tower-top nacelle that is yawed relative to the tower in order to align the rotor with the wind. Either a transmission and generator combination or a larger, direct drive generator, are commonly used.

The state of the art includes offshore wind turbines that rest on the ocean bottom and are neither built nor intended to be moved. In waters shallower than 60 m, wind turbines used for offshore applications commonly include single-tower systems mounted to the sea bed. In deeper waters the turbines must float, using spar-buoy or semi-submersible platforms, tension legs, or a large-area barge-type construction. Offshore turbines are usually connected to a local power grid and electrical energy produced is transferred by ocean-floor grid structures.

Hydrogen produced from renewable energy sources is considered a carbon-free fuel Electrolysis is the process of using electricity to split water into hydrogen and oxygen. The reaction takes place in an electrolyzer, which comprises an anode and a cathode separated by an electrolyte. Various electrolyte materials produce different types of electrolyzers. Common electrolyzers include solid-oxide electrolyzers, alkaline electrolyzers and polymer-electrolyte-membrane electrolyzers.

A polymer-electrolyte membrane (PEM) electrolyzer uses a solid polymeric material wherein water is split at the anode to form oxygen and positively charged hydrogen ions. Electrons flow through an external circuit and the hydrogen ions move across the PEM to the cathode. At the cathode, hydrogen ions combine with electrons from the external circuit to form hydrogen gas. The anode reaction is as follows:

2H₂ yields→O₂+4H⁺+4e⁻

The cathode reaction is as follows:

4H⁺+4e⁻ yields→2H₂

One skilled in the art understands that electrical energy from a wind driven shaft may be employed to convert various raw materials to fluid fuels by various processes. For example methanol, DME, hydrazine or other compounds with or without carbon may be harvested from an environment. For the purpose of clarity, the present application refers to the conversion of electrical energy to hydrogen, followed by the incorporation of this hydrogen into a carbon free fluid fuel. The meaning of carbon free is that carbon is not emitted in creating the fuel, and that any carbon emitted in using the fuel was previously taken from the atmosphere to create the fuel.

Increased adoption of renewable electricity challenges utilities to balance supply and demand on an energy-distribution grid. When the wind blows harder than needed, generation must be curtailed because customers cannot use it. Conversely when the wind blows less than needed, customers cannot be served unless there is a stored energy option or a backup fuel-powered generating plant.

### SUMMARY

A method and apparatus for converting mechanical energy from wind to fluid-fuel energy is an offshore wind turbine with associated fuel synthesis hardware. Electrical energy generated by the turbine is used to convert water to fuel. In some embodiments the fuel is liquid hydrogen.

In an example embodiment, an apparatus has at its central portion a horizontal structure that is configured to support electrical-generation equipment driven by a wind-turbine rotor. This rotor center is supported on a plurality of legs, each with a shallow float at the base.

Electrical energy is used in an electrolysis process to convert sea water to hydrogen. In some embodiments a polymer electrolyte membrane (PEM) electrolyzer converts sea water into hydrogen gas. Gaseous hydrogen may be stored in tanks that may be located beneath the water surface, on the ocean floor. In some embodiments the sub-sea hydrogen storage tanks are cylindrical culvert pipes containing gas-impermeable bladder, located 500 meters or more beneath the water's surface, providing appropriate compression for low volume (hence low cost) storage.

A wind turbine that produces a stored fuel such as hydrogen can eliminate many problems associated with renewable energy. Turbines powered by a combination of wind and hydrogen can provide adequate power independent of when the wind blows.

Other objects and features will become apparent from the following detailed description considered in conjunction with the accompanying drawings. It is to be understood, however, that the drawings are designed as an illustration and not as a definition of the limits of the invention.

### BRIEF DESCRIPTION OF THE DRAWINGS

FIG. 1 is a perspective view of an example embodiment of the present disclosure;

FIG. 2 is diagram thereof.

### DESCRIPTION

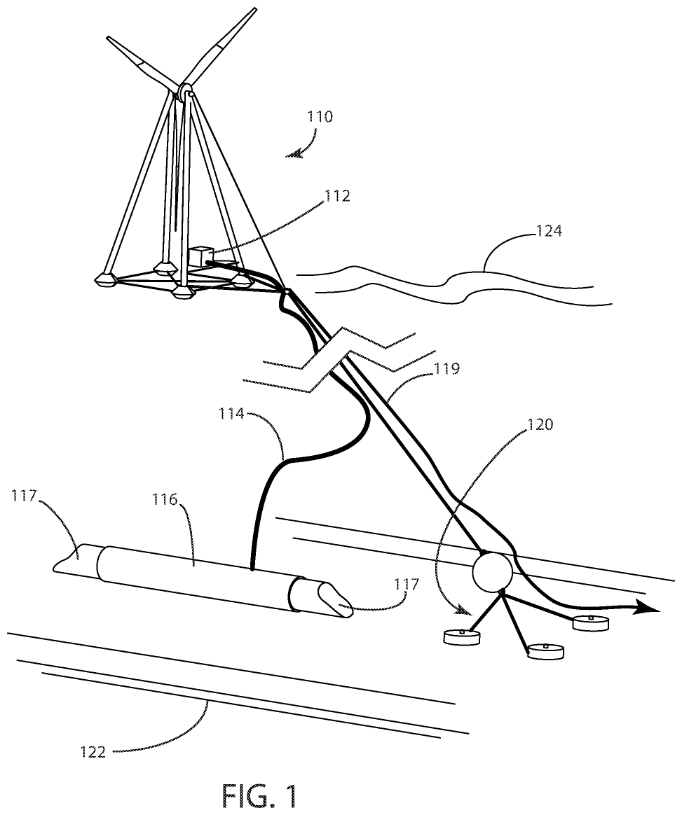

FIG. 1 is a perspective view of an example embodiment 100. A wind turbine 110 floats on the ocean surface 124. The turbine 110 is moored to the ocean floor by mooring apparatus 120. Electrical energy generated by the wind turbine is used to convert water to hydrogen in an electrolyzer 112. Hydrogen is transferred along conduit 114 to a storage container 116, located at least 500 M beneath the ocean surface 124, on the ocean floor 122. In some embodiments a storage container 116 may be a series of culvert pipes containing a bag or bladder. 117. One skilled in the art understands that a bag or bladder prevents diffusion of the stored gas into water. One skilled in the art also understands that a series of such storage modules may be capped off at both ends.

In one embodiment, hydrogen in a storage container 116 may be sent back to the electrolyzer (also referred to as a fuel cell) 112 to convert the hydrogen to electricity so as to supply electricity to a grid when the wind velocity is low. In combination, an electrical connection from the wind-turbine electrical-generating apparatus, to a grid, coupled with an electrical connection from a fuel cell to the grid, provides uninterrupted electrical power regardless of wind conditions.

One skilled in the art understands that a hydrogen fuel cell produces electricity from hydrogen. One skilled in the art also understands that a wind turbine and a tidal turbine may be interchanged for the purpose of the disclosure. The functional characteristics of a wind turbine may be replaced by the functional characteristics of a water turbine. For clarity, the disclosure refers to a wind turbine.

A conduit 119 transfers electricity to a land-based grid connection. By managing electrical energy produced by the wind turbine 110 and by the electrolyzer 112, a continuous supply of electrical energy is provided.

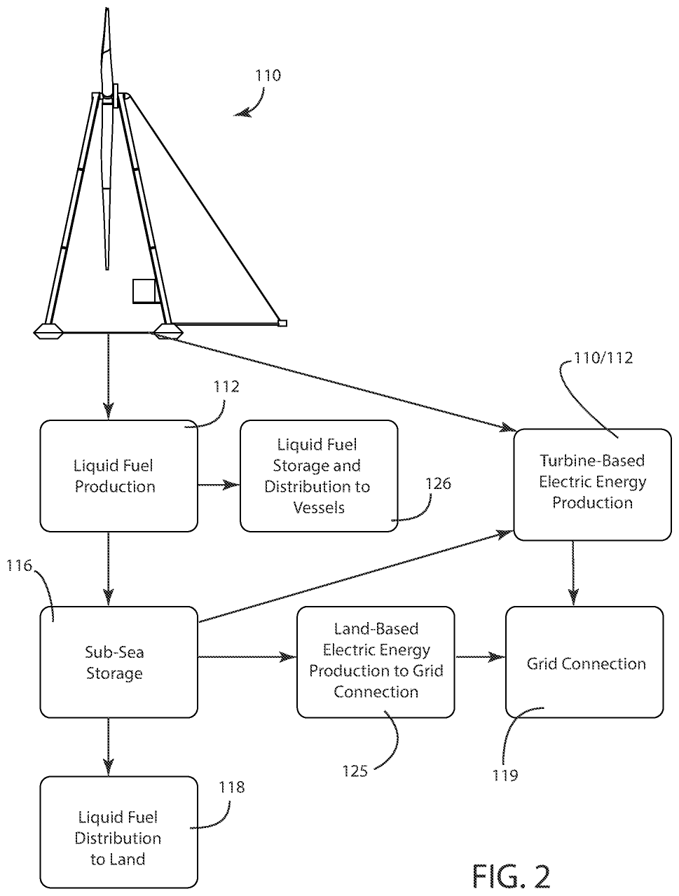

FIG. 2 is a diagram depicting the flow of fuel and energy in the systems depicted in FIG. 1. A wind turbine 110 generates electricity for fuel production in a fuel cell 112. Produced fuel, such as hydrogen, may be stored in a sub-sea storage container 116 that is economical if deep water is available to keep the gas compressed. Gaseous fuel in the sub-sea storage container 116 may be used to produce electricity in a fuel cell 112 based on the turbine 110. Electricity produced by the wind turbine 110 and by the fuel cell 112 on the turbine is transferred to a grid connection 119.

The example embodiments described herein should not be construed as limiting.

1. A method for producing electricity using a virtual hydrogen battery, the method comprising:
generating electricity with an offshore fluid turbine; and
powering an electrolyzer with said electricity; and
separating hydrogen from water with said electrolyzer; and
storing said hydrogen; and
powering an electrolyzer with said stored hydrogen; and
producing electricity with said electrolyzer.

2. The method for producing electricity using a virtual hydrogen battery of claim 1 further comprising:
distributing said hydrogen in sub-sea storage container to land based electrolyzer and electricity distribution apparatus.

3. The method for producing electricity using a virtual hydrogen battery of claim 1 further comprising:
distributing said hydrogen in sub-sea storage container to a sea faring vessel.

4. The method for producing electricity using a virtual hydrogen battery of claim 1 further comprising:
distributing said hydrogen in sub-sea storage container to land-based electric energy production apparatus; and
producing electric energy; and
distributing said electric energy to an energy grid.

5. The method for producing electricity using a virtual hydrogen battery of claim 1 further comprising:
generating electricity by way of said electrolyzer and said hydrogen stored in said sub-sea container; and
distributing said electricity to an energy grid.

6. A method for producing electricity using a virtual hydrogen battery, the method comprising:
generating electricity with an offshore fluid turbine supporting a rotor with a lattice structure supported by shallow draft floats; and
distributing at least a first portion of said electricity to a land-based energy grid; and
powering an electrolyzer with at least a second portion of said electricity; and
separating hydrogen from water with said electrolyzer; and
storing said hydrogen in a sub-sea storage container; and
powering said electrolyzer with said stored hydrogen; and
distributing a second portion of said electricity to said land-based energy grid.
